(19) United States
(12) Patent Application Publication
(10) Pub. No.: US 2018/0215329 A1
(43) Pub. Date: Aug. 2, 2018

(54) INSULATING ISOLATOR ASSEMBLY

(71) Applicant: DANA AUTOMOTIVE SYSTEMS GROUP, LLC, MAUMEE, OH (US)

(72) Inventors: SAMUEL W. LEUTHOLD, CHICAGO, IL (US); ERNEST A. OXENKNECHT, NAPERVILLE, IL (US)

(73) Assignee: DANA AUTOMOTIVE SYSTEMS GROUP, LLC, MAUMEE, OH (US)

(21) Appl. No.: 15/747,162

(22) PCT Filed: Jul. 22, 2016
(86) PCT No.: PCT/US2016/043662

§ 371 Date: Jan. 24, 2018

Related U.S. Application Data
(60) Provisional application No. 62/196,635, filed on Jul. 24, 2015.

(51) Int. Cl. B60R 13/08; F01N 13/14; F16F 15/04

(52) U.S. Cl. CPC B60R 13/0876; F01N 13/14; F16F 2234/06; F01N 2260/20; F16F 15/04

(57) ABSTRACT

An insulating isolator assembly for a heat shield including an isolator guide with wire mesh isolator located thereon and a mounting insert wherein the mounting insert has a set of tabs that aid in attaching the mounting insert to the heat shield and the isolator guide in inserted through an aperture of the mounting insert. The isolator guide having a tube having a first end with a first retaining feature thereon and a second end with a second retaining feature thereon which retains the wire mesh isolator on the isolator guide. When the isolator guide extends through the aperture of the mounting insert, the first retaining feature and isolator remain on one side of the mounting insert, while the tube and the second retaining feature of the isolator guide extend through the other side of the mounting insert.

### RELATED APPLICATIONS

The present application claims the benefit of U.S. Provisional Application No. 62/196,635 filed on Jul. 24, 2015, the entire disclosure of which is hereby incorporated by reference.

### FIELD

The present disclosure relates to an insulating isolator assembly for a heat shield that isolates the heat shield from both vibrations and heat.

### BACKGROUND

In today's modern vehicles, the exhaust components of internal combustion engines can reach under-the-hood temperatures in the neighborhood of 1600 degrees Fahrenheit. Such high temperatures can create significant risks of damage to components, such as electronic components, nested under the hood. Thus, protection is warranted, and has been provided via use of heat shields designed to cover up, or partially block, and hence to insulate, exhaust components, turbo chargers, catalysts, downpipes and other heat generating components.

Exhaust heat shields conventionally mount to the exhaust components of an internal combustion engine using mounting connections including stand-off brackets or mounting bosses. The heat shields are secured to the exhaust components by at least one bolt or fastener that extends through the heat shield and into the mounting connections. Typically, the heat shield is connected to the exhaust component in more than one location.

Internal combustion engines and the exhaust systems vibrate substantially during use. These vibrations along with the heat from the engine or exhaust system can transmit through the mounting connection and/or the fastener and into the heat shield. These vibrations can cause the heat shield to rattle, generating noise causing the heat shield to fatigue prematurely and crack.

The heat conducting through the mounting connections into the heat shield can also damage the heat shield, which can be made of a lightweight material, such as aluminum, whose tensile strength and fatigue limits drop as the temperature increases.

Additionally, the noise cause by the vibrations can be heard inside or outside of the vehicle and is objectionable to consumers.

Therefore, it would be desirable to reduce or eliminate vibrations that may emanate from the vehicle heat shield and reduce the heat conducting through the mounting connections to the heat shield.

### SUMMARY

An insulating isolator assembly for a heat shield including an isolator guide including a tube having an outer diameter, a first end with a first retaining feature thereon, a second end having a second retaining feature thereon, and an aperture of a constant inner diameter extending through from the first end to the second end. The first and second retaining features have outer diameters greater than an outer diameter of the tube.

In one embodiment, the insulating isolator assembly can further include a wire mesh isolator having an upper surface, a lower surface in direct contact with the first retaining feature, an aperture extending therethrough and an outer diameter substantially equivalent to the outer diameter of the first retaining feature, wherein the aperture receives the tube of the isolator guide therein; and a mounting insert having an annular portion with an upper surface and a lower surface that meet at a common outer diameter edge, a set of circumferentially spaced tabs attached to the outer diameter edge, a set of gaps separating each of the tabs from one another, and a central aperture extending through the upper and lower surfaces, wherein the central aperture receives the tube of the isolator guide therein.

In another embodiment, the insulating isolator assembly can include a spring disk having an inner circular edge, an outer circular edge, a central aperture for receiving the tube of the isolator guide therein, and circumferentially spaced radially outward extending openings extending from the inner circular edge; a mounting insert having an annular portion with an upper surface and a lower surface that meet at a common outer diameter edge, a set of circumferentially spaced tabs attached to the outer diameter edge, a set of gaps separating each of the tabs from one another, and a central aperture extending through the upper and a lower surfaces, wherein the central aperture receives the tube of the isolator guide therein, and wherein the outer circular edge of the spring disk contacts the annular portion of the mounting insert and the inner circular edge contacts the tube of the isolator guide below the first retaining feature.

### BRIEF DESCRIPTION OF THE DRAWINGS

The above, as well as other advantages of the present embodiments, will become readily apparent to those skilled in the art from the following detailed description when considered in the light of the accompanying drawings in which:

FIG. 1 is a top perspective view of a preferred embodiment of an insulating isolator assembly in a heat shield;

FIG. 2 is bottom perspective view of a preferred embodiment of a mounting insert in a heat shield;

FIG. 3 is a bottom perspective view of a preferred embodiment of a mounting insert;

FIG. 4 is a bottom perspective view of a preferred embodiment of the insulating isolator assembly of FIG. 1 without the heat shield;

FIG. 5 is a-cross-sectional side view of a preferred embodiment of a wired mesh isolator;

FIG. 6 is a bottom perspective view of the preferred embodiment of the isolator guide and isolator;

FIG. 7 is a top perspective view of a preferred embodiment of the insulating isolator assembly of FIG. 1 without the heat shield;

FIG. 8 is a top view of a spring disk of the insulating isolator assembly of FIG. 7;

FIG. 9 is a top perspective view of another preferred embodiment of an insulating isolator assembly in a heat shield;

FIG. 10 is a bottom view of the preferred embodiment of an insulating isolator assembly in a heat shield of FIG. 9;

FIG. 11 is a top perspective view of an embodiment of a wire mesh isolator; and

FIG. 12 is top perspective view of a preferred embodiment of a mounting insert in a heat shield.

### DETAILED DESCRIPTION OF THE PREFERRED EMBODIMENTS

It is to be understood that the embodiments may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments

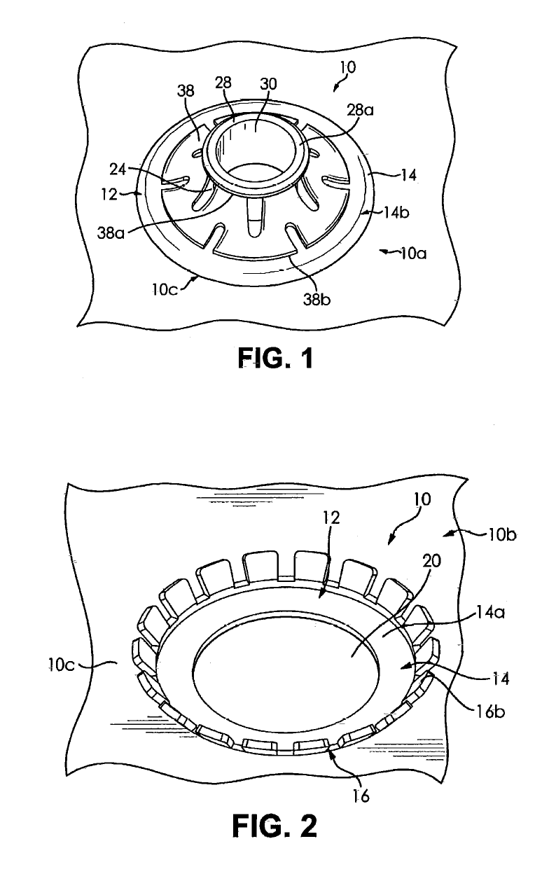

FIG. 1 depicts a portion of one embodiment of a heat shield 10 with an insulating isolator assembly 12 attached thereto. As depicted, the heat shield 10 is a multi-layer heat shield, but can also be a single layer heat shield. The heat shield 10 can include an upper sheet or surface 10a, a lower sheet or surface 10b (as shown in FIG. 2). Additionally, at least one intermediate layer (not shown) can be located between the upper and lower surfaces or sheets 10a, 10b. The intermediate layer(s) may be constructed of nonmetallic materials. Nonmetallic materials include, but are not limited to, high-temperature resisting fiber materials, compressed mica particles, compressed vermiculite particles, and/or other minerals resistant to heat. The upper and lower surfaces 10a, 10b are constructed of metallic materials including, but not limited to, lightweight aluminum.

The size and shape of the heat shield 10 can vary depending on the application requirement. The heat shield 10 may provide both thermal and acoustical insulation of an object such as, but not limited to, an internal combustion engine, an exhaust system or a temperature sensitive component (not shown).

The heat shield 10 has an aperture 10c that receives a mounting insert 14 that receives a fastener (not shown), such as a bolt, to connect the heat shield 10 to a mounting structure (not shown). The mounting structure may be on an engine, an exhaust component, a turbo charger, a catalyst, downpipes of a high temperature component or any other structure that requires shielding from heat. The aperture 10c extends entirely through the heat shield 10. The aperture 10c, as shown, is round, but can also be, but is not limited to, oval or polygonal depending on the shape and size of the mounting structure, mounting insert 14 and fastener.

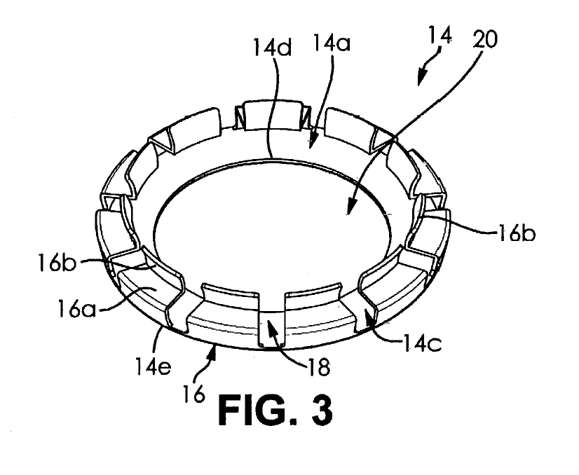

As shown in FIG. 2, the mounting insert 14 is located in the aperture 10c. In one embodiment, as shown in FIG. 3, the mounting insert 14 has a planar, annular portion 14a having an upper surface 14b (as shown in FIG. 1), a lower surface 14c, an inner diameter edge 14d and an outer diameter edge 14e. The annular portion 14a has a constant thickness between the upper surface 14b and lower surface 14c. The upper surface 14b and lower surface 14c meet at the outer diameter edge 14e. Extending from the outer diameter edge 14e of the annular portion 14a is a set of circumferentially spaced tabs 16 with a set of gaps 18 separating each of the tabs 16 from one another. As depicted, the mounting insert 14 planar surface 14a is annular, but can also be, but not limited to, square, polygonal, oval or irregular in shape.

In one embodiment, each tab 16 includes a radially inward extending leg 16a and an axially outward extending leg 16b connected to the radially inward extending leg 16a. The radially inward extending leg 16a offsets the axially outward extending leg 16b inwardly from the outer diameter edge 14e of the mounting insert 14. All of the tabs 16 extend in substantially the same direction from the annular potion 14a. The tabs 16 can have various shapes and sizes including, but not limited to, petal-shapes.

Alternatively, the tabs 16 can be replaced with a continuous circumferential flange that extends through and around the aperture 10c of the heat shield 10. The circumferential flange can include a radially inward extending portion and an axially outward extending portion connected to the radially inward extending portion, wherein the axially outward extending portion is bent to attach the mounting insert 14 to the heat shield 10.

The tabs 16 are designed to assist the mounting insert 14 in attaching to the heat shield 10 as shown in FIG. 2. The mounting insert 14 is located in the aperture 10c of the heat shield 10. More particularly, when the mounting insert 14 is inserted into the aperture 10c of the heat shield 10, the radially inward extending legs 16a of the tabs 16 extend through the aperture 10c of the heat shield 10. The tabs 16 can extend through a single heat shield 10 or multiple heat shields. When the insulating isolator assembly 12 is assembled on the heat shield 10, the tabs 16 are bent so that they contact the heat shield 10. More particularly, the axially extending legs 16b of each tab 16 are to be located adjacent or in contact with the lower surface 10b of the heat shield 10. The radially inwardly extending leg 16a of each tab 16 is located adjacent or in contact with the upper surface 10a of the heat shield 10. The heat shield 10, therefore, is sandwiched between the legs 16a, 16b of the tabs 16 to secure the mounting insert 14 in place.

A central aperture 20 extends the through annular portion 14a of the mounting insert 14. As shown in FIG. 3, the central aperture 20 is round; however, the central aperture 20 can also be, but is not limited to, oval, polygonal or other shapes depending on the application. Preferably, the central aperture 20 is centered in the annular portion 14a of the mounting insert 14. The central portion 20 receives the fastener that further connects with the mounting structure.

In one embodiment, the mounting insert 14 is constructed of a metallic material. The mounting insert 14 provides a degree of thermal protection from the heat conducted into the mounting insert 14 from the mounting structure. The thermal protection comes in the form of the surface area of the mounting insert 14 by virtue of its design, shape and features (described below) and the conductivity of the metallic material. Dispersing conductive heat flux along ever increasing volume of the mounting insert 14. Additionally, every surface to surface contact creates a disruption the in the flow of conductive heat from the fasteners.

The vibration protection comes in the form of the deflection of the mounting insert 14 in the axial direction and can be tuned via thickness changes and addition of features to change the axial stiffness of the mounting insert 14.

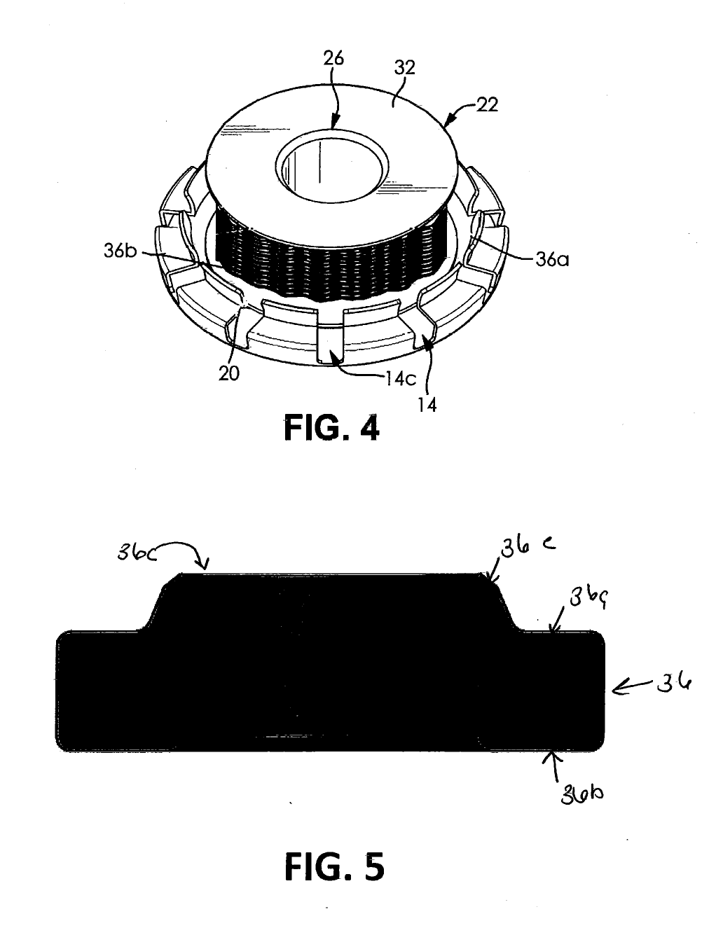

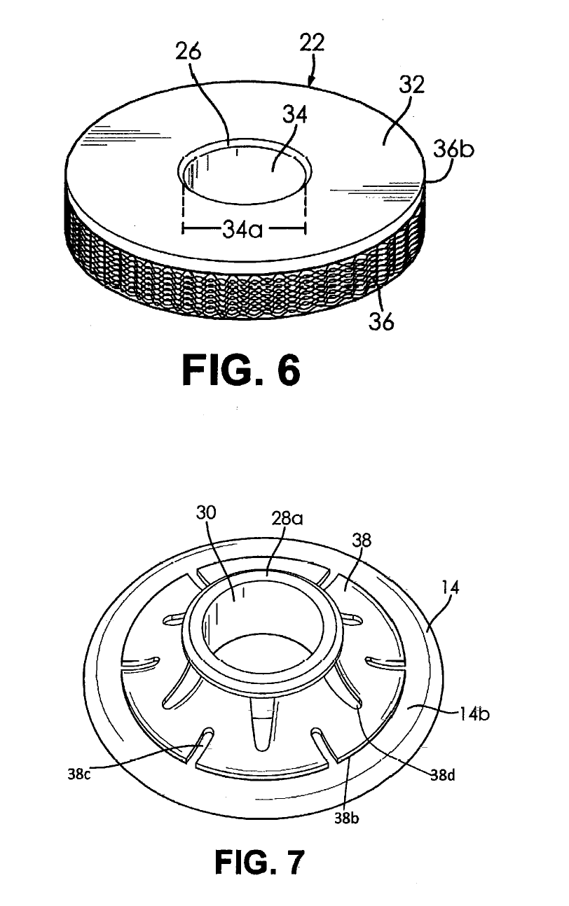

In one embodiment, as can be appreciated from FIG. 4, an isolator guide 22 is inserted through the central aperture 20 of the mounting insert 14. As depicted in FIG. 6, the isolator guide 22 includes a hollow tube 24 having a first end 26, a second end 28 and a central portion 30.

Attached to the first end 26 is a retaining feature 32 having an outer diameter 32a than is larger than the outer diameter 24a of the tube 24. In one embodiment, the retaining feature 32 is a washer, but can also be, but is not limited to, a ridge or other similar feature. The second end 28 of the hollow tube 24 has a second retaining feature 28a having an outer diameter greater than the outer diameter 24a of the tube tub 24. The first retaining feature 32, the first end 26, the second end 28, the second retaining feature 28 and the central portion 30 are of one-piece construction. An aperture 34 with a constant inner diameter 34a extends through the first retaining feature 32, through the first end 26 to the second end 28 creating the hollow interior of the hollow tube 24. As shown in FIG. 1, the retaining feature 28a is a ridge, but can also be, but is not limited to, a washer or other similar feature.

In one embodiment, when the isolator guide 22 is inserted through the central aperture 20 of the mounting insert 14, the first end 26 is located below the lower surface 14c of the mounting insert 14 as shown in FIG. 4. The central portion 30 and the second end 28 extend through the mounting insert 14 and the heat shield 10 as shown in FIG. 1. At least the second end 28 extends beyond the upper surface 10a of the heat shield 10 and the upper surface 14b of the mounting insert 14.

An isolator component 36 is located about the tube 24 of the isolator guide 22, as shown in FIG. 4. In one embodiment the isolator component is a wire mesh isolator 36 having a generally cylindrical shape with an upper surface 36a, a lower surface 36b and an aperture 36c extending from the upper surface 36a to the lower surface 36b as shown in FIG. 5. The lower surface 36b of the wire mesh isolator 36 abuts the first retaining feature 32 and the central portion 30 of the tube 24 extends through the aperture 36c. The upper surface 36d of the wire mesh isolator 36 extends partially along the central portion 30 of the tube 24. Additionally, the wire mesh isolator 36 has an outer diameter that is substantially equivalent or smaller than the outer diameter of the first retaining feature 32.

When the isolator guide 22 is inserted through the central aperture 20 of the mounting insert 14, the lower surface 36b of the wire mesh isolator 36 abuts the first retaining feature 32 and the upper surface 36a abuts the annular portion 14a of the mounting insert 14 as shown in FIG. 4. The wire mesh isolator 36 is sized such that the wire mesh isolator 36 does not fit through the central aperture 20 of the annular portion 14a.

In one embodiment, when the isolator guide 22 is inserted through the central aperture 20 of the mounting insert 14, the first retaining feature 32 and the first end 26 are located above the upper surface 14b of the mounting insert 14. The central portion 3D and the second end 28 extend through the mounting insert 14 and the heat shield 10. At least the second end 28 extends beyond the lower surface 10b of the heat shield 10 and the lower surface 14c of the mounting insert 14.

The wire mesh isolator 36 may be constructed of a wire mesh material. The wire mesh material is preferably a knitted wire mesh, although other types of wire meshes, e.g., woven and expanded metal meshes, can be used if desired. More particularly, the wire mesh isolator 36 may constructed of a voided metal mesh material that is woven with a plurality of wires intertwined with one another. The wire mesh making up the wire mesh structure can be composed of various materials and those materials can be subjected to various treatments (including coatings) either before or after being formed into a mesh. Examples of suitable materials and treatments include, but are not limited to, carbon steel, stainless steel, 300 and 400 series, tin-plated carbon steel, zinc-plated carbon steel, and galvanized carbon steel. The wires making up the wire mesh can have various cross-sections, including, without limitation, round, hexagon, octagon, square, and flat.

The wire mesh isolator 36 functions to reduce the heat and vibration transfer through the mounting structures of the engine or exhaust component into the heat shield 10. More particularly, the wire mesh isolator 36 dissipates heat and vibration from the mounting structure and the mounting insert 14 so that the heat shield 10 is not damage.

The wire mesh material has a large voided surface area in which cooling air can pass through and take heat away. The wire mesh isolator 36 reduces heat and vibration from the connecting point(s) to the heat shield 10 through the wire mesh material. The wire mesh acts as a spring dampener that receives vibration from any radial and axial direction from the fastener. The individual wires of the mesh material contact one another when vibration is received and dissipate the vibration throughout the rest of the mesh material. The wire mesh material can withstand the high temperatures conducted through mounting structure and mounting insert 14 without melting, deforming or changing performance.

The wire mesh isolator 36 is separated from the heat shield 10 by the mounting insert 14. The wire mesh material of the wire mesh isolator 36 can create high contact stresses in the heat shield 10. Additionally, the mounting insert 14 is constructed of a metal material that can withstand the high contact stresses of the wire mesh of the wire mesh isolator 36. Further, the interface between the mesh material of the wire mesh isolator 36 and the mounting insert 14 provides additional surface area and the additional transition between the two materials functions to reduce heat transfer and vibration. The interface between the mounting insert 14 and heat shield 10 is rigid to eliminate damage to the heat shield 10 from movement/friction.

Additionally, in one embodiment, the aperture 36c near the upper surface 36a of the wire mesh isolator 36 can have an increased diameter portion 36f. The increased diameter portion 36f is sized such that the second retaining feature 28a on the second end 28 of the isolator guide 22 fits inside the increased diameter portion 36f of the wire mesh isolator 36, but not through the aperture 36c, i.e. the diameter of the increased diameter portion 36f is greater than the outer diameter of the second retaining feature 28a of the isolator guide 22. The similar increased diameter portion 36f can be located near the lower surface 36b of the wire mesh isolator 36.

In another embodiment, the aperture 36c near the upper surface 36a of the aperture 36 may have an upstanding portion 36e as shown in FIG. 5. The upstanding portion 36e has the same inner diameter as the aperture 36c and an outer diameter that is smaller than the outer diameter of the second retaining feature 28a. Therefore, when assembled, the second retaining feature 28a of the isolator guide 22 is retained on the top of the upstanding portion 36e.

Additionally, as shown in FIG. 11, the aperture 36c near the upper surface 36a can have an increased diameter portion 36f larger than the outer diameter of the second retaining feature 28a.

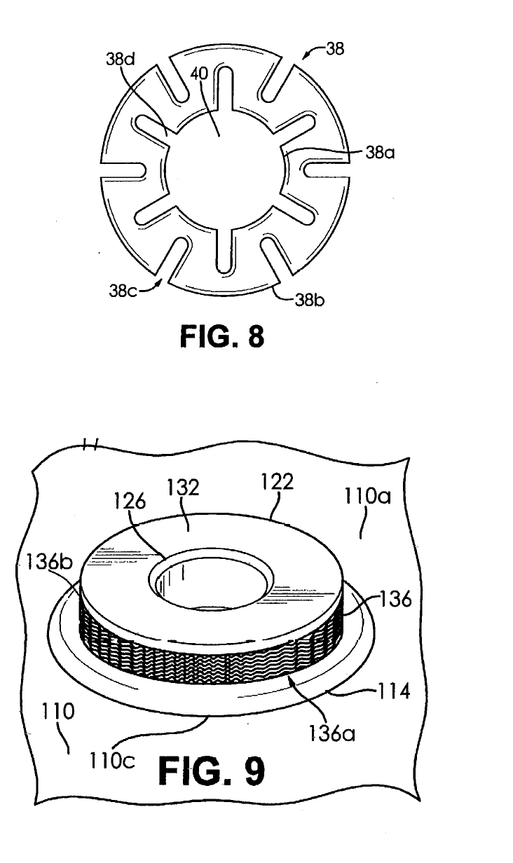

In another embodiment, the isolator component is a spring disk 38 as shown in FIGS. 1 and 7. In this embodiment, second retaining feature 28a keeps the spring disk 38 in place on the hollow tube 24 as shown in FIGS. 1 and 7. The spring disk 38 is depicted in further detail in FIG. 8. The spring disk 38 has a substantially planar disk shape. The spring disk 38 has a central aperture 40 extending through the spring disk 38 creating an inner circular edge 38a. The spring disk 38 also has an outer circular edge 38b. The outer circular edge 38b can have circumferentially spaced openings 38c, or slits, extending radially inward therefrom toward the inner circular edge 38a, but not touching the inner circular edge 38a. Additionally, the inner circular edge 38a can have circumferentially spaced openings 38d, or slits, extending radially outward therefrom toward the outer circular edge 38b, but not touching the inner circular edge 38b. The slits 38c, 38d are positioned on the spring disk 38 such that the slits 38c, 38d alternate circumferentially with each other.

The spring disk 38 can be made of a flexible metal material including, but not limited to, spring steel. As noted above, the shape of the circumferentially spaced openings 38c, 38d may vary as well as the thickness and the material stiffness of the spring disk 38 to provide the desired variability and flexibility to allow the spring disk 38 to absorb vibrational and thermal strain. In one embodiment, the openings 38c, 38d are u-shaped.

In one embodiment, the mounting insert 14 separates the wire mesh isolator 36 from the spring disk 38 as shown in FIG. 1. In one embodiment, when the isolator guide 22 is inserted through the aperture 10c of the heat shield 10, the first retaining feature 32 and the first end 26 are located below the lower surface 10b of the heat shield 10 and the spring disk 38, the second end 28 and part of the tube 24 of the isolator guide 22 are located above the upper surface 10a of the heat shield 10. The tube 24 of the isolator guide 22 extends through the central aperture 40 of the spring disk 38 as shown in FIG. 1. The outer edge 38b is in contact with upper surface 14b of the annular portion 14a. The inner edge 38a is in contact with the central portion 30 the tube 24. The inner edge 38a contacts the central portion 30 below the second retaining feature 28a of the second end 28. The central aperture 40 is sized such that the central portion 30 of the tube 24 fits through the aperture 40, but the second retaining feature 28a will not extend through the aperture 40. Thus, the second retaining feature 28a retains the spring disk 38 between the upper surface 14b of the annular portion 14a and the second end 28 of the tube 24.

In another embodiment, when the isolator guide 22 is inserted through the aperture 10c of the heat shield 10, the first retaining feature 32 and the first end 26 are located above the upper surface 10a of the heat shield 10 and the spring disk 38, the second end 28 and part of the tube 24 of the isolator guide 22 are located below the lower surface 10b of the heat shield 10.

In another embodiment, the insulating isolator assembly 12 includes an isolator guide 22 having two spring disks 38 thereon. In this embodiment, the mounting insert 14 separates the two spring disks 38 from each other. The spring disks 38 are placed on the tube 24 such that the inner edge 38a of the spring disks contact the central portion 30 below the first and second retaining features 32, 28a respectively and the mounting insert separates the outer edges 38b from each. Thus, the retaining features 32, 28a retain the spring disks 38 between surfaces 14b, 14c of the annular portion 14a and first and second ends 26, 28 of the tube.

When the isolator guide 22 is inserted through the aperture 10c of the heat shield 10, the first end 26 and one spring disk 38 is located below the lower surface 10b of the heat shield 10 and the second spring disk 38 and the second end 28 are located above the upper surface 10a of the heat shield 10. The tube 24 of the isolator guide 22 extends through the central apertures 40 of the spring disks 38.

Preferably, the first and second retaining features 32, 28a are ridges.

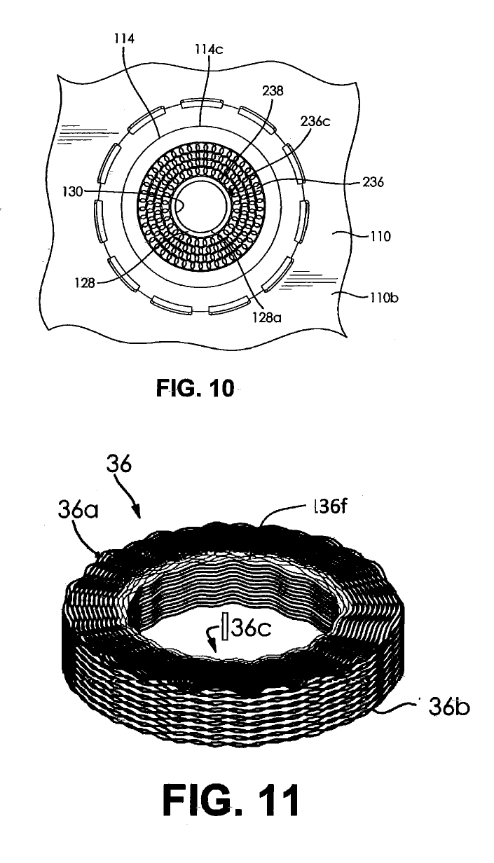

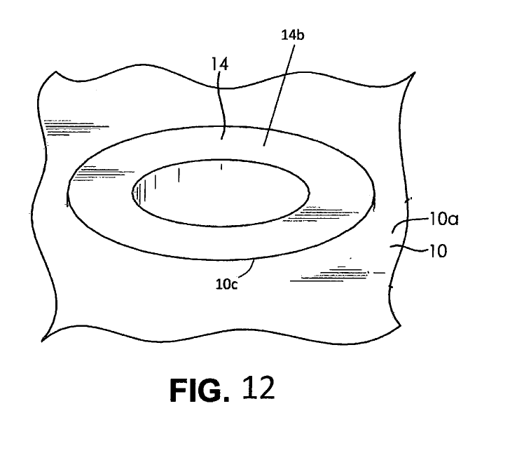

In another embodiment, as shown in FIGS. 9 and 10, an insulating isolator assembly 112 includes an isolator guide 122 having two wire mesh isolators 136, 236 thereon. When the isolator guide 122 is inserted through the aperture 110c of the heat shield 110, the first end 126 is located above the upper surface 110a of the heat shield 110 as shown in FIG. 9. The central portion 130 and the second end 128 of the isolator guide 122 extend through the mounting insert 114 and the heat shield 110. At least the second end 128 extends beyond the lower surface 110b of the heat shield 110, as shown in FIG. 10.

A first wire mesh isolator 136 is located about the central portion 130, as shown in FIG. 9. The first wire mesh isolator 136 has a generally cylindrical shape with an upper surface 136a, a lower surface 136b and an aperture 136c extending from the upper surface 136a to the lower surface 136b as shown in FIG. 11. The lower surface 136b isolator 136 abuts the washer 132 and the central portion 130 of the tube 124 extends through the aperture 136c. The upper surface 136a of the first wire mesh isolator 136 extends partially along the central portion 130 of the tube 124.

When the isolator guide 122 is inserted through the aperture 110c of the heat shield 110 and the central aperture 120 of the mounting insert 114, lower surface 136b of the first wire mesh isolator 136 abuts the washer 132 and the upper surface 136a abuts the upper surface 114b of the mounting insert 114 as shown in FIG. 9. The first wire mesh isolator 136 is sized such that the first wire mesh isolator 136 does not fit through the central aperture 120 of the mounting insert 114.

A second wire mesh isolator 236 is positioned below the lower surface 110b of the heat shield 110 around the central portion 130 of the tube 124 between the lower surface 114c of the annular portion 114a of the mounting insert 114.

In one embodiment, when assembled, the lower surface 236b of the second wire mesh isolator 236 abuts the annular portion 114a of the mounting insert 114 and the upper surface 236a extends along the central portion 130 of the tube 124.

Additionally, the second end 128 can retain the second wire mesh isolator 236 via a press fit or an interference fit to maintain the second wire mesh isolator 236 thereon.

When assembled, the mounting insert 114 substantially separates the two isolators 136, 236 from the each other. More particularly, when the isolator guide 122 is inserted through the aperture 110c of the heat shield 110, the washer 132 and the first end 126 are located above the upper surface 110a of the heat shield 110 and the second wire mesh isolator 236, the second end 128 and part of the tube 124 of the isolator guide 122 are located above the lower surface 110b of the heat shield 110 as shown in FIGS. 9 and 10. The tube 124 of the isolator guide 122 extends through the apertures 136c, 236c of the wire mesh isolators 136, 236.

The aperture 236c of the second wire mesh isolator 236 is sized such that the central portion 130 of the tube 124 fits through the aperture 236c, but the ridge 128a will not extend entirely through the aperture 236c. Thus, the ridge 128a retains the second wire mesh isolator 236 between on the tube portion 124 of the mounting insert 114.

In one embodiment, the wire mesh isolators 136, 236 may be partially in contact with one another.

In accordance with the provisions of the patent statutes, the present invention has been described in what is considered to represent its preferred embodiments. However, it should be noted that the embodiments can be practiced otherwise than as specifically illustrated and described without departing from its spirit or scope.

We claim:

1. An insulating isolator assembly for a heat shield comprising:
an isolator guide comprising a tube having an outer diameter, a first end with a first retaining feature thereon, a second end having a second retaining feature thereon, and an aperture having a constant inner diameter extending through from the first end to the second end, wherein the first and second retaining features have outer diameters greater than an outer diameter of the tube;
a wire mesh isolator having an upper surface, a lower surface in direct contact with the first retaining feature, an aperture extending therethrough and an outer diameter substantially equivalent to the outer diameter of the first retaining feature, wherein the aperture receives the tube of the isolator guide therein; and
a mounting insert having an annular portion with an upper surface and a lower surface that meet at a common outer diameter edge, a set of circumferentially spaced tabs attached to the outer diameter edge, a set of gaps separating each of the tabs from one another, and a central aperture extending through the upper and lower surfaces, wherein the central aperture receives the tube of the isolator guide therein.

2. The insulating isolator assembly of claim 1, wherein each tab comprises a radially inward extending leg and an axially outward extending leg connected to the radially inward extending leg, wherein the axially outward extending legs are bent to attach the mounting insert to the heat shield.

3. The insulating isolator assembly of claim 1, wherein the upper surface of the wire mesh isolator is in contact with the annular portion of she mounting insert.

4. The insulating isolator assembly of claim 1, further comprising a spring disk having an inner circular edge, an outer circular edge, a central aperture for receiving the tube of the isolator guide therein, and circumferentially spaced radially outward extending openings extending from the inner circular edge, wherein the inner circular edge is smaller in diameter than the diameter of the first and second retaining features and wherein the outer circular edge contacts the annular portion of the mounting insert and the inner circular edge contacts the tube of the isolator guide below the second retaining feature.

5. The insulating isolator assembly of claim 4, wherein the spring disk further comprises circumferentially spaced radially inward extending openings extending from the outer circular edge.

6. The insulating isolator assembly of claim 1, wherein the second retaining feature is a ridge.

7. The insulator isolator assembly of claim 1, wherein the first retaining feature is a washer.

8. The insulating isolator assembly of claim 1, wherein the isolator guide is of one-piece construction.

9. The insulating isolator assembly of claim 1, further comprising a second wire mesh isolator having an upper surface, a lower surface in direct contact with the lower surface of the mounting insert, an aperture extending through the second wire mesh isolator and an outer diameter substantially equivalent to the outer diameter of the first retaining feature, wherein the aperture receives the tube of the isolator guide therein.

10. The insulating isolator assembly of claim 1, wherein the upper surface of the wire mesh isolator has an upstanding portion.

11. An insulating isolator assembly for a heat shield comprising:
an isolator guide comprising a tube having an outer diameter, a first end with a first retaining feature thereon, a second end having a second retaining feature thereon, and an aperture having a constant inner diameter extending through from the first end to the second end, wherein the first and second retaining features have outer diameters greater than an outer diameter of the tube;
a wire mesh isolator having an upper surface, a lower surface in direct contact with the first retaining feature, an aperture extending therethrough and an outer diameter substantially equivalent to the outer diameter of the first retaining feature, wherein the aperture receives the tube of the isolator guide therein;
a mounting insert having an annular portion with an upper surface and a lower surface that meet at a common outer diameter edge, a circumferential flange extending from the common outer diameter edge and a central aperture extending through the upper and lower surfaces, wherein the central aperture receives the tube of the isolator guide therein and wherein the flange is bent to attach the mounting insert to the heat shield.

12. An insulating isolator assembly for a heat shield comprising:
an isolator guide comprising a tube having an outer diameter, a first end with a first retaining feature thereon, a second end having a second retaining feature thereon, and an aperture having a constant inner diameter extending through from the first end to the second end, wherein the first and second retaining features have outer diameters greater than an outer diameter of the tube;
a spring disk having an inner circular edge, an outer circular edge, a central aperture for receiving the tube of the isolator guide therein, and circumferentially spaced radially outward extending openings extending from the inner circular edge;
a mounting insert having an annular portion with an upper surface and a lower surface that meet at a common outer diameter edge, a set of circumferentially spaced tabs attached to the outer diameter edge, a set of gaps separating each of the tabs from one another, and a central aperture extending through the upper and a lower surfaces, wherein the central aperture receives the tube of the isolator guide therein, and
wherein the outer circular edge of the spring disk contacts the annular portion of the mounting insert and the inner circular edge contacts the tube of the isolator guide below the first retaining feature.

13. The insulating isolator assembly of claim 12, further comprising a second spring having an inner circular edge, an outer circular edge, a central aperture for receiving the tube of the isolator guide therein, and circumferentially spaced radially outward extending openings extending from the inner circular edge, wherein the inner circular edge is smaller in diameter than the diameter of the first and second retaining features and wherein the outer circular edge contacts the annular portion of the mounting insert and the inner circular edge contacts the tube of the isolator guide below the second retaining feature.

14. The insulating isolator assembly of claim 12, wherein the first and second retaining features are ridges.
